(19) United States
(12) Patent Application Publication
(10) Pub. No.: US 2008/0110250 A1
(43) Pub. Date: May 15, 2008

(54) TIRE PRESSURE MONITORING DEVICE, SYSTEM AND METHOD

(76) Inventor: Russell F. Jones, Black Sand Beach, HI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/551,650

(22) Filed: Oct. 20, 2006

(51) Int. Cl. G01M 17/02

(52) U.S. Cl. 73/146

(57) ABSTRACT

A device, system, and method for monitoring tire pressure of a vehicle, involving a sensor having a structure for carrying a primary current to generate a primary electromagnetic field; and a pressure target module having a structure for inducing a secondary current to generate a secondary electromagnetic field when disposed in a vicinity of the sensor during a revolutionary incident.

### TECHNICAL FIELD

The present invention technically relates to tire devices, systems, and methods. More particularly, the present invention technically relates to tire pressure sensing devices, systems, and methods. Even more particularly, the present invention technically relates to automotive and aerospace tire pressure monitoring devices, systems, and methods.

### BACKGROUND ART

The currently existing art involves manually measuring tire pressure, for land vehicles, using a hand-held tire pressure gauge. The problems with this technique include the need to halt the motor vehicle before any measurement can be made and the inherent inaccuracy of the measurement, itself. Another related art method for assessing tire pressure is the physical inspection or “eye-balling” of the tires, which involves observing, wear indicators while the vehicle is stopped (Prior Art FIGS. 1a-1f). For example, excessive wear at the centerline of the tire 1, i.e., “center tread wear,” indicates over-pressurization (Prior Art FIG. 1b) while excessive wear at the periphery of the tire 2, i.e., “shoulder wear,” indicates under-pressurization (Prior Art FIG. 1a). An under-inflated tire (Prior Art FIG. 1a) is vulnerable to overheating and possibly igniting, as well as “rim bruises,” e.g., if a tire impacts uneven road, a rock, a rut, a pothole, or a curb, the tire has a tendency to flex to an extent such that the tire material will become “pinched” by the rim, thereby leading to early tire failure. In the case of an over-inflated tire (Prior Art FIG. 1b), by riding on its centerline, uneven stresses are introduced into the tire material, thereby weakening or failing the tire. A feathered edge 3 indicates “toe-in” wears or “toe-out” wear, e.g., alignment (Prior Art FIG. 1c). Excessive wear on one side of the tire tread 4 indicates side wears or camber wear (Prior Art FIG. 1d). A rounded edge 5a or a rough surface 5b (abraded) of the outboard shoulder of the tire is a visual sign of cornering wear (Prior Art FIG. 1e). A “cupped” or carved-out portion 6 of the tread is indicative if multi-problem wear, e.g., balancing, alignment, etc. (Prior Art FIG. 1f). Clearly, by the time wear indicators appear, the tire has already been structurally compromised. Such primitive methods are not conducive to an early diagnosis.

Other, slightly more advanced techniques for land vehicles, include in-situ tire pressure monitoring systems using a magnet and a sensor; however, such systems tend to attract excess iron (ferric pickup) from the environment, e.g., from the brake pads, rotor or brake shoes and drum wear thereby imparting inaccurate measurements over time. Another related art system has been developed for land vehicles, the system comprising a sensor which transmits a radio frequency signal to indicate low tire pressure and a monitor, thereby setting off a visible and audible alarm to the driver which has a potential problem of conflicting radio frequency transmissions. Another compares the number of revolutions of each wheel to the others to obtain inflation differentials, which is only accurate when vehicles are operated in a straight line. Another related art tire pressure monitoring system includes a visual valve cap (VVC) which changes color, e.g., to red, when the tire is under-pressurized and which requires that the driver halt the motor vehicle, walk around the vehicle, and visually inspect each cap for such color change.

In addition to land vehicles, tire pressure monitoring has been even more challenging with respect to aerospace vehicle landing gear and systems. On a typical airliner, the landing gear may, for example, comprise twelve tires, bearing the load of the aircraft, itself, the passengers, and the payload against the normal and frictional forces of a taxiway or a runway. The main wheels may be approximately 3 feet in diameter outfitted with tires of approximately over 4 feet in diameter. On landing, the aircraft tires may accelerate from zero to 150 mph in 0.1 second. Under these conditions, the landing gear tires tend to bulge and emit a friction generated shrieking sound, while the tread may experience temperatures of approximately 500° F. In sum, take-off and landing are conditions for cyclic torturing of landing gear systems, especially the tires. While runway friction contributes to landing gear tire wear, the principal factors are actually steering stress and crosswind loads which are influenced by drag and aerodynamic friction components. The portion of the tire which is not in contact with the ground at any given instance is subject to crosswinds during roll-out as well as to steering forces during taxiing.

Other aerospace vehicles, facing tire pressure monitoring issues, include the Space Shuttle with its tremendous loads, e.g., 240,000 lbs. on landing as well as naval and marine fighter craft which must take-off and land on the deck of an aircraft carrier, i.e., a short “runway” which is in constant motion (subject to the sea's wave action). In an attempt to address the problems in the aerospace industry, the landing gear systems have been provided with a large steel tube carriage comprising a plurality of wires transmitting signals from a plurality of primitive strain gauges attached to a plurality of elements in the landing gear system as well as to the carriage itself. Another landing gear tire pressure monitoring system comprises a retrofitted valve stem that is installed in the wheel which sends a radio frequency signal to an onboard system in the cockpit or to the maintenance crew using a handheld device on the ground. However, the potential problem of conflicting radio frequency transmissions still exists. Yet, other related art devices in the aerospace field have been developed which monitor overall landing gear system health; however, these devices make only primitive measurements which are stored and then downloaded later at certain intervals of time. This data may assist in servicing and maintenance, but does not provide a real-time solution for avoiding emergency situations.

Along with the foregoing problems experienced in the related art, in both land as well as in aerospace vehicles, the principle of “flotation” is key. From basic physics, to avoid a point load, a given load should be distributed across the surface (a distributed load). Hence, both inland freight vehicles and aerospace vehicles comprise a plurality of tires for distributing their loads on the highway and the runway, respectively. As such, the ability to accurately and reliably monitor the tire pressure of each tire in a plurality of tires is of utmost significance in terms of safety as well as economy. Thus, a long-felt need is seen to exist for a system and method for both land and aerospace vehicles which provides in-situ real-time continuous and simultaneous monitoring of the tire pressure.

### DISCLOSURE OF THE INVENTION

The present invention involves a device, system, and method for in-situ real-time continuous and simultaneous monitoring of the tire pressure, i.e., as the tires rotate, as well as displaying the real-time tire pressure data on an instrument panel, e.g., a dash instrument panel in a land vehicle and a flight instrument panel on an aerospace vehicle. In general, the present invention uses eddy currents in the monitoring of tire pressure. Eddy currents are induced in a mass of conductive material which is disposed or moving in the vicinity of an electromagnetic field. These currents are generally circulatory in nature. The alternating current in a primary winding of a conductive material sets an alternating flux in the core of the primary winding, thereby inducing an electromotive force in the secondary winding. Energy is transferred from the one winding to another via the core flux and its associated induced electric field.

The present invention device for monitoring tire pressure of a vehicle generally comprises a sensor having a structure for carrying a primary current to generate a primary electromagnetic field; and a pressure target module having a structure for inducing a secondary current to generate a secondary electromagnetic field when disposed in a vicinity of the sensor during a revolutionary incident.

The present invention system for monitoring tire pressure of a vehicle generally comprises a device for monitoring tire pressure, the device comprising: a sensor having a structure for carrying a primary current to generate a primary electromagnetic field; a pressure target module having a structure for inducing a secondary current to generate a secondary electromagnetic field when disposed in a vicinity of the sensor during a revolutionary incident; and a processor being in electronic communication with the sensor, the processor providing an alternating current to the sensor of the device.

The present invention method for monitoring tire pressure of a vehicle generally comprises the steps of: providing a device for monitoring tire pressure, the device providing step comprising the steps of: providing a sensor having a structure for carrying a primary current to generate a primary electromagnetic field; providing a pressure target module having a structure for inducing a secondary current to generate a secondary electromagnetic field when disposed in a vicinity of the sensor during a revolutionary incident; and providing a processor being in electronic communication with the sensor, the processor providing an alternating current to the sensor of the device.

A logistic advantage of the present invention is the in-situ real-time simultaneous monitoring of tire pressure for all tires on a motor vehicle, e.g., from passenger vehicles to multiple-wheeled vehicles for inland freight and beyond to aerospace vehicle landing gear. Safety advantages include providing an early warning system, reducing out-of-control vehicles, reducing stopping distance, reducing flat tires, tire blow-out and early detection of a wheel assembly malfunction, thereby reducing personal injury and fatalities. Economic benefits include improving fuel economy, prolonging tread life, reducing property damage, reducing travel delay, reducing device and system weight, resisting corrosion, eliminating pickup of ferrous materials, oil, dirt, moisture, resisting interference by other electrical signals, resisting influence by magnetic fields, early warning with respect to wheel assembly and wheel base problems as indicated by patterns in tire pressure variation, and commencing counting of tire rotations or vehicle operational distance after a tire pressure problem has been identified for facilitating accident or products liability investigations. Other features of the present invention are disclosed, or are apparent, in the section entitled “Detailed Description of the Invention,” disclosed, infra.

### BRIEF DESCRIPTION OF THE DRAWINGS

For a better understanding of the present invention, reference is made to the below-referenced accompanying Drawings. Reference numbers refer to the same or equivalent parts of the present invention throughout the several figures of the Drawings.

FIGS. 1a-1f are frontal views of six tires, each tire exemplifying a visual indication of typical wear; in accordance with the prior art “eye-balling” method.

FIG. 2 is a frontal cross-sectional view of a tire pressure monitoring device, shown in schematic relation to an overall tire pressure monitoring system, showing configuration of the pressure target module applicable for embedding within the inside surface of a wheel or a wheel spoke surface, by example only, in accordance with the present invention.

FIG. 2a is a frontal cross-sectional view of a tire pressure-monitoring device, shown in schematic relation to an overall tire pressure monitoring system, in accordance with the present invention.

FIG. 3 is a frontal cross-sectional view of a shock strut sensor-mounting bracket and tire pressure-monitoring device, as installed within a front wheel assembly of a land vehicle, in accordance with the present invention.

FIG. 3a is a frontal cross-sectional view of a shock strut sensor-mounting bracket that is a continuous part of the shock strut and tire pressure-monitoring device, as installed within a front wheel assembly of a land vehicle, in accordance with the present invention.

FIG. 4 is a front view of a mounting for a sensor portion of a tire pressure monitoring device, as installed within a rear wheel assembly and disposed under a plurality of axle end flange bolts, by example only, in accordance with the present invention.

FIG. 5 is a front view of a mounting for a sensor portion of a tire pressure monitoring device, as installed within a rear wheel assembly and disposed under a plurality of wheel cylinder bolts, by example only, in accordance with the present invention.

FIG. 5a is a front view of a backing plate sensor mount, wherein the mount is made such that it is a continuous part of the backing plate, by example only, in accordance with the present invention.

FIG. 6 is a perspective view of a tire pressure monitoring system, as installed within a nose gear assembly of an aerospace vehicle wheel and lower portion of shock strut, such as an aircraft by example only, in accordance with the present invention.

FIG. 7 is a side view of a tire pressure monitoring system, as installed within a nose gear assembly of an aerospace vehicle wheel and lower portion of shock strut, such as an aircraft by example only, in accordance with the present invention.

FIG. 8 is a front view of a tire pressure monitoring system, as installed within a nose gear assembly of an aerospace vehicle, such as an aircraft by example only, in accordance with the present invention.

FIG. 9 is a perspective view of a tire pressure monitoring system, as installed within a wing gear assembly of an aerospace vehicle, such as an aircraft by example only, in accordance with the present invention.

FIG. 10 is a side view of a tire pressure monitoring system, as installed within a wing gear assembly of an aerospace vehicle, such as an aircraft by example only, in accordance with the present invention.

FIG. 11 is a front view of a tire pressure monitoring system, as installed within a wing gear assembly of an aerospace vehicle, such as an aircraft by example only, in accordance with the present invention.

FIG. 12 is a top view of a pressure target module of a tire pressure monitoring device, as embedded in the inside surface of a wheel or a wheel spoke surface, by example only, in accordance with the present invention.

FIG. 13 is a top and bottom view of a pressure target module of a tire pressure monitoring device, showing configuration of the pressure target module applicable for embedding within the inside surface of a wheel or a wheel spoke surface, by example only, in accordance with the present invention.

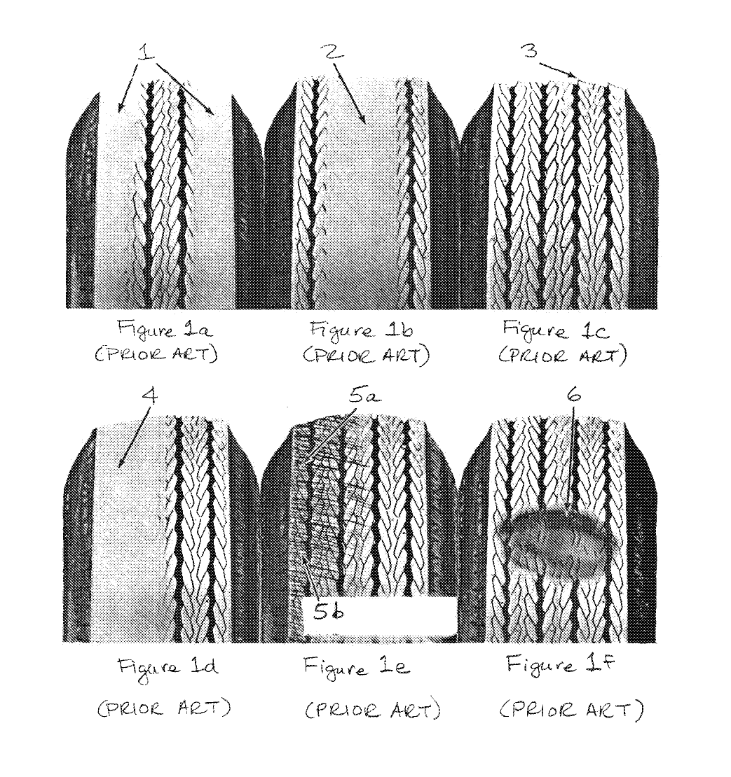

### MODES FOR CARRYING OUT THE INVENTION

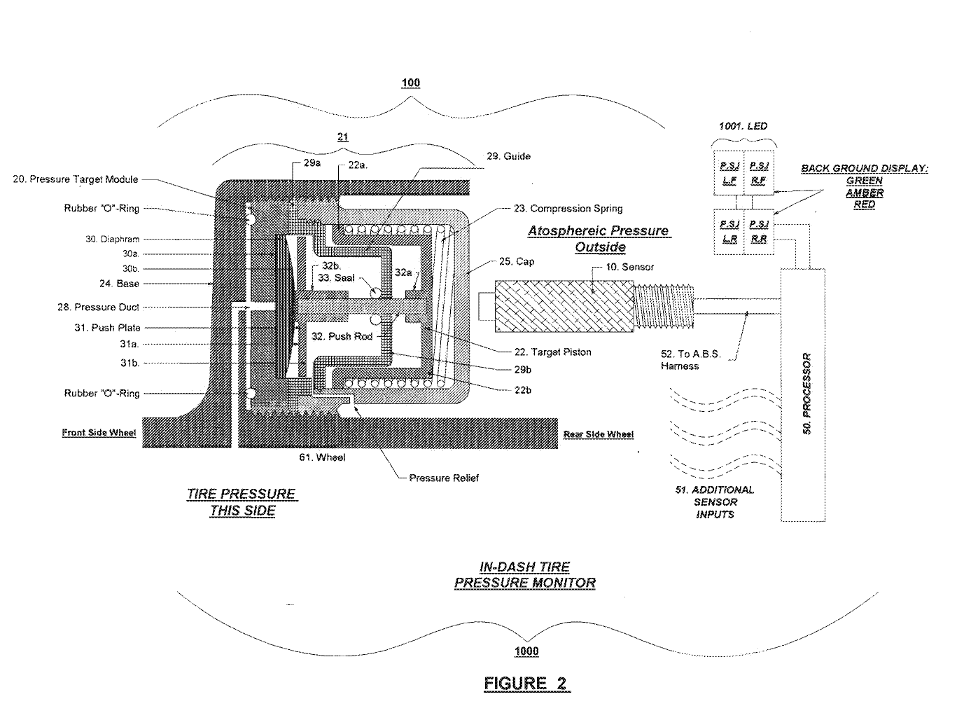

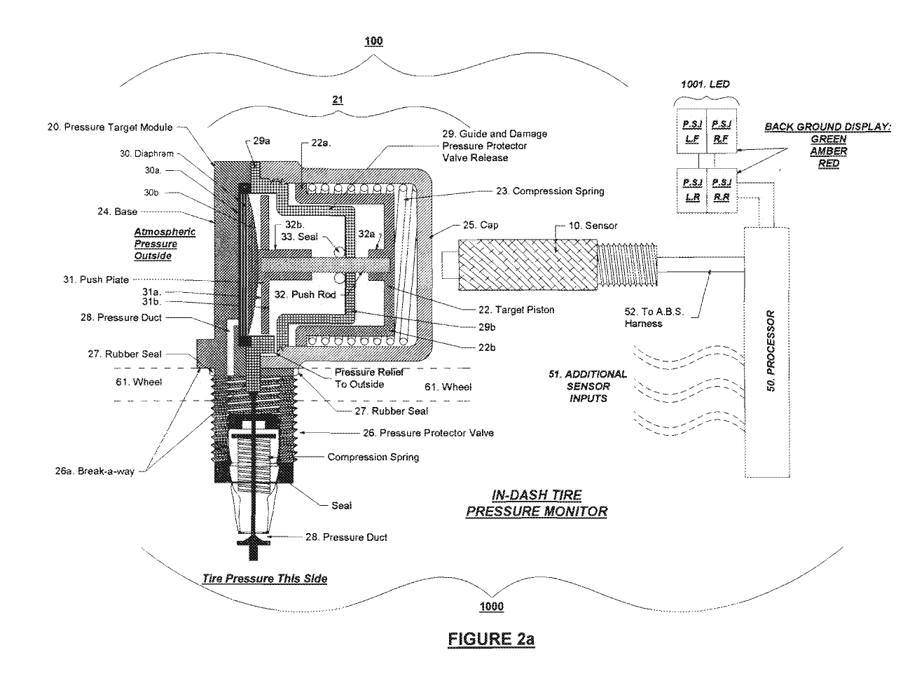

FIGS. 2 and 2a are frontal cross-sectional views of a tire pressure monitoring device 100, shown in schematic relation to a tire pressure monitoring system 1000, in accordance with the present invention. The present device 100 for monitoring tire pressure of a vehicle comprises a sensor 10 having a structure for carrying a primary current to generate a primary electromagnetic field E₁ (not shown); and a pressure target module 20 having a structure for inducing a secondary current to generate a secondary electromagnetic field E₂ (not shown) when disposed in a vicinity of the sensor 10 during a revolutionary incident. The secondary electromagnetic field E₂ opposes the primary electromagnetic field E₁. The secondary electromagnetic field E₂ also diminishes the primary electromagnetic field E₁, whereby impedance in the sensor 10 is varied, and whereby an output current from the sensor 10 is varied.

Referring to FIG. 2, the pressure target module 20 comprises a housing 21; and a secondary current target piston inducing structure 22 and a compression spring 23, the compression spring 23 having a spring length Lₛ. Both the piston 22 and the spring 23 are disposed within the housing 21. The piston 22 exerts a force on the spring 23, whereby the spring length Lₛ is varied. The housing 21 comprises a base 24 and a cap 25. The pressure target module 20 by example only, is embedded within the inside surface of a wheel 61 or within a wheel spoke surface (not shown). The placement of the pressure target module 20, within the inside surface of a wheel 61 or within a wheel spoke surface (not shown), may serve to protect it from potentially being dislodged. The pressure target module 20 further comprises a structure for pushing. The pressure target module 20 comprises a pressure duct 28 in fluid communication with the inflation media in a tire 200 (not shown) and the pushing structure.

Referring to FIG. 2a, the pressure target module 20 comprises a housing 21; and a secondary current target piston inducing structure 22 and a compression spring 23, the compression spring 23 having a spring length Lₛ. Both the piston 22 and the spring 23 are disposed within the housing 21. The piston 22 exerts a force on the spring 23, whereby the spring length Lₛ is varied. The housing 21 comprises a base 24 and a cap 25. The pressure target module 20 comprises a pressure protector valve 26, the pressure protector valve 26 coupling the housing 21 to the wheel 61. The pressure target module 20 comprises a rubber seal 27 disposed between the pressure protector valve 26 and the housing 21. The pressure target module 20 further comprises a structure for pushing. The pressure target module 20 comprises a pressure duct 28 in fluid communication with the inflation media in a tire 200 (not shown) and the pushing structure. The term “inflation media in a tire” as used herein, may for example be gas, air, liquid or other substances used in the art to inflate a tire. The pressure protector valve 26 serves to guard the inflation media in a tire from escaping in the event the pressure target module 20 is dislodged, for example by road debris, dried mud, ice or buildup inside the wheel. The pressure protector valve 26 is released allowing the compression spring within the pressure protector valve 26 to close the pressure duct 28.

In addition in FIG. 2a, the pushing structure comprises a guide 29 having a release feature; a diaphragm 30 having a forward surface 30a and an aft surface 30b and being disposed forward of the release feature; a push plate 31 having a forward surface 31a and an aft surface 31b, the push plate forward surface 31a interfacing the diaphragm aft surface 30b; and a push rod 32 having a proximal end 32a and a distal end 32b, the push rod distal end 32b being mechanically coupled to the push plate aft surface 31b, the push rod proximal end 32a being mechanically coupled with the target piston 22, and the push rod 32 having a push rod seal 33 disposed between the push rod 32 and the guide 29.

Specifically, a pressurized fluid 40 from the pressure duct 28 exerts a force upon the diaphragm 30. The diaphragm 30, in turn, exerts the force upon the push plate 31. The push plate 31, in turn, then exerts the force upon the push rod 32. The push rod 32, in turn, exerts the force upon the target piston 22. Consequently, the target piston 22 exerts the force upon the compression spring 23, whereby the secondary electromagnetic field E₂ (not shown) of the conductive target piston is moved.

In addition in FIGS. 2 and 2a, a variation ΔIₒ in the output current 10 (not shown) comprises a feature such as an increasing output current which is effected by an increasing spring length and a decreasing output current which is effected by a decreasing spring length. The target piston 22 comprises a flange portion 22a and a conductive target piston body portion 22b. The target piston flange portion 22a exerts the force on the compression spring 23. The conductive target piston body portion 22b is disposed within the compression spring 23 for minimizing the overall size of the pressure target module 20. The guide 29 comprises a flange portion 29a and a body portion 29b. The guide flange portion 29a is fastened to the housing 21. The guide body portion 29b is disposed within the target piston body portion 22b for minimizing the overall size of the pressure target module 20.

Also referring to the schematic portion of FIGS. 2 and 2a, the present system 1000 for monitoring tire pressure of a vehicle comprises a device 100 for monitoring tire pressure, the device 100 comprising: a sensor 10 having a structure for carrying a primary current I₁ to generate a primary electromagnetic field E₁; a pressure target module 20 having a structure for inducing a secondary current I₂ to generate a secondary electromagnetic field E₂ when disposed in a vicinity of the sensor 10 during a revolutionary incident; and a processor 50 being in electronic communication with the sensor 10, the processor 50 providing an alternating current (AC) to the sensor 10 of the device 100. The processor 50 comprises additional sensor inputs 51. An ABS harness 52 may act as a conduit between the sensor 10 and the processor 50. The present system 1000 further comprises a light emitting diode (LED) 1001 disposed on an instrument panel (not shown) corresponding to the device 100.

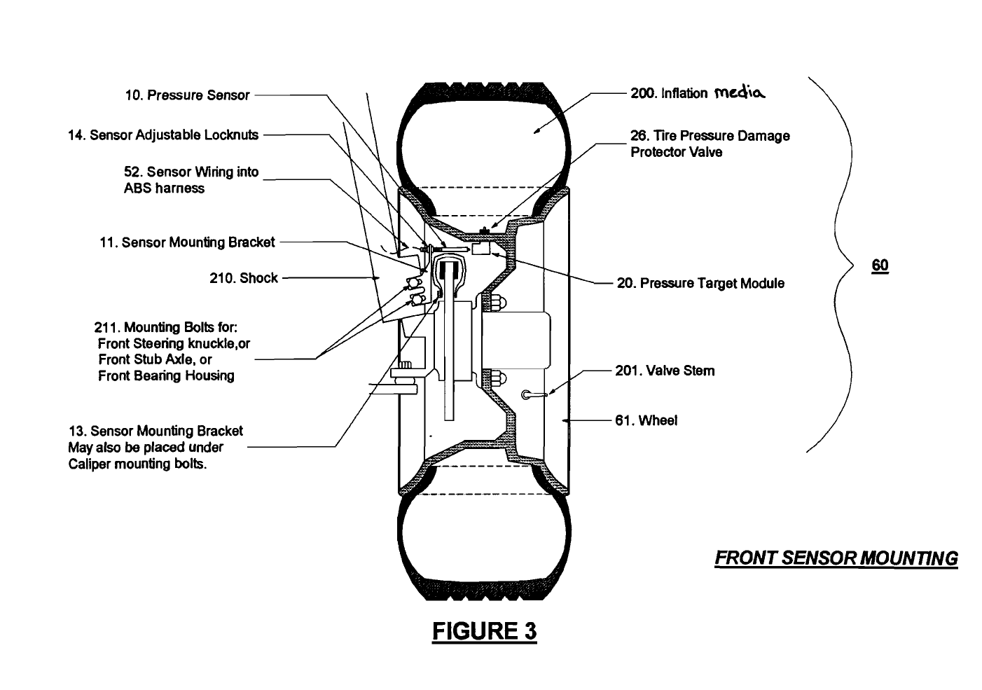

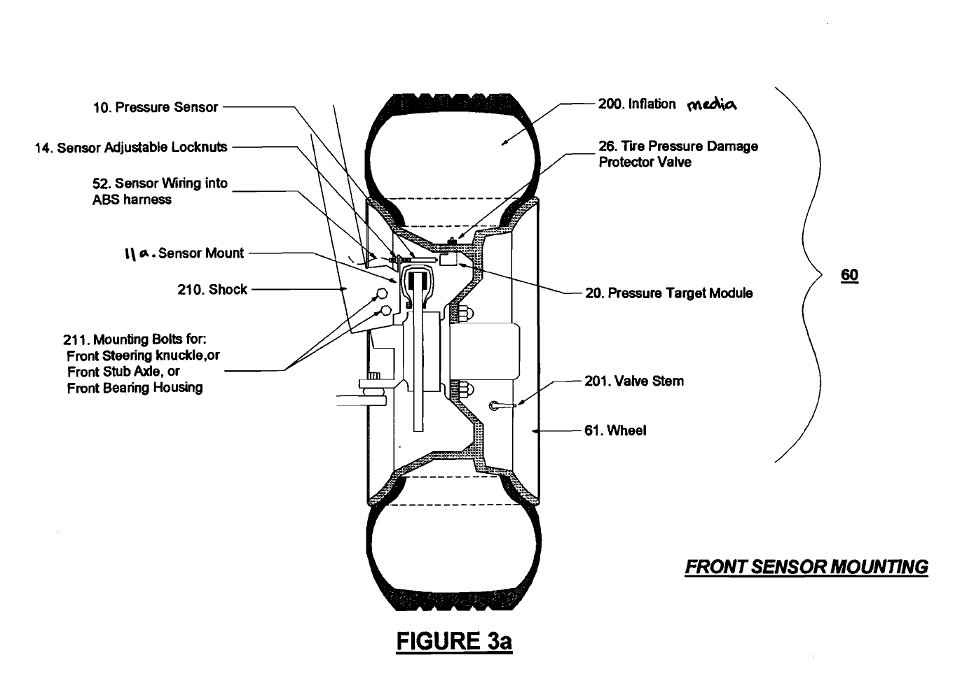

FIG. 3 is a frontal cross-sectional view of a shock strut 210 sensor-mounting bracket 11 and tire pressure-monitoring device 100, as installed within a front wheel assembly 60 of a land vehicle (not shown), in accordance with the present invention. The pressure target module 20 is mounted behind a front wheel 61 of the land vehicle at a zero breadth expansion contraction point. The sensor 10 is mounted parallel to the pressure target module on a non-revolutionary front structure 210 of the land vehicle. The pressure target module 20, having the pressure protector value 26, is disposed through the front wheel 61 at a zero breadth expansion contraction point and into the inflation media in a tire 200, having a value stem 201. The system 1000 further comprises a sensor-mounting bracket 11. The sensor-mounting bracket 11 is fastened to the non-revolutionary structure 210 of the land vehicle. The non-revolutionary structure 210 comprises a structure such as a front steering knuckle, a front axle stub, and a front bearing housing. Mounting bolts 211 may be used as a fastener. The system 1000 further comprises a sensor-mounting bracket 11 having a bore 12 (not shown) being coincident with a caliper-mounting bolt 13 of the land vehicle. The system 1000 further comprises a plurality of adjustable locknuts 14 for adjusting a position of the sensor 10.

FIG. 3a is a frontal cross-sectional view of a shock strut 210 sensor-mounting bracket 11a that is a continuous part of the shock strut 210 and tire pressure-monitoring device 100, as installed within a front wheel assembly 60 of a land vehicle (not shown), in accordance with the present invention. The pressure target module 20 is mounted behind a front wheel 61 of the land vehicle at a zero breadth expansion contraction point. The sensor 10 is mounted parallel to the pressure target module on a non-revolutionary front structure 210 of the land vehicle. The pressure target module 20, having the pressure protector value 26, is disposed through the front wheel 61 at a zero breadth expansion contraction point and into the inflation media in a tire 200, having a value stem 201. The system 1000 further comprises a sensor mount 11a. The sensor mount 11a is a continuous part of the non-revolutionary structure 210 of the land vehicle. The non-revolutionary structure 210 comprises a structure such as a front steering knuckle, a front axle stub, and a front bearing housing. Mounting bolts 211 may be used as a fastener. The system 1000 further comprises a sensor mount 11a having an elongated hole or slot (not shown) for the sensor 10 to be adjusted or moved. The system 1000 further comprises a plurality of adjustable locknuts 14 for adjusting a position of the sensor 10.

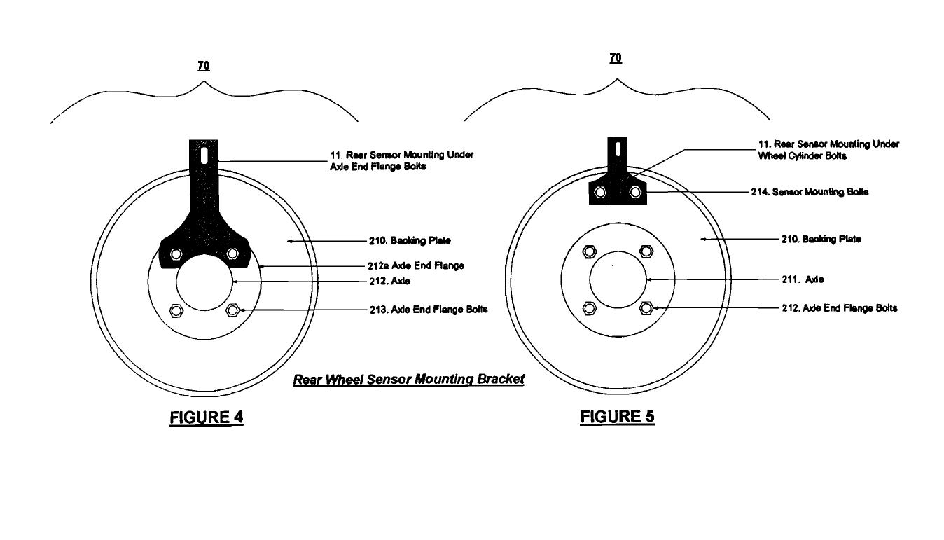

FIG. 4 is a front view of a mounting for a sensor 10 portion of a tire pressure-monitoring device 100 (not shown), as installed within a rear wheel assembly 70, by example only, in accordance with the present invention. The device 100 (not shown) is mounted behind a rear wheel 61 (not shown) of a land vehicle (not shown). The sensor 10 is mounted to a non-revolutionary structure 212a of a land vehicle, e.g., an axle end flange, by mounting bracket 11 under a fastener 213 such as an axle end flange bolt. The pressure target module 20 is disposed through the rear wheel 61 and into the inflation media in a tire 200 (not shown) using the configuration shown in FIG. 2a. Alternatively, the pressure target module 20 is disposed within the inside surface of the rear wheel 61 or the rear wheel spoke surface (not shown), which interfaces with the inflation media in a tire 200 (not shown) using the configuration shown in FIG. 2.

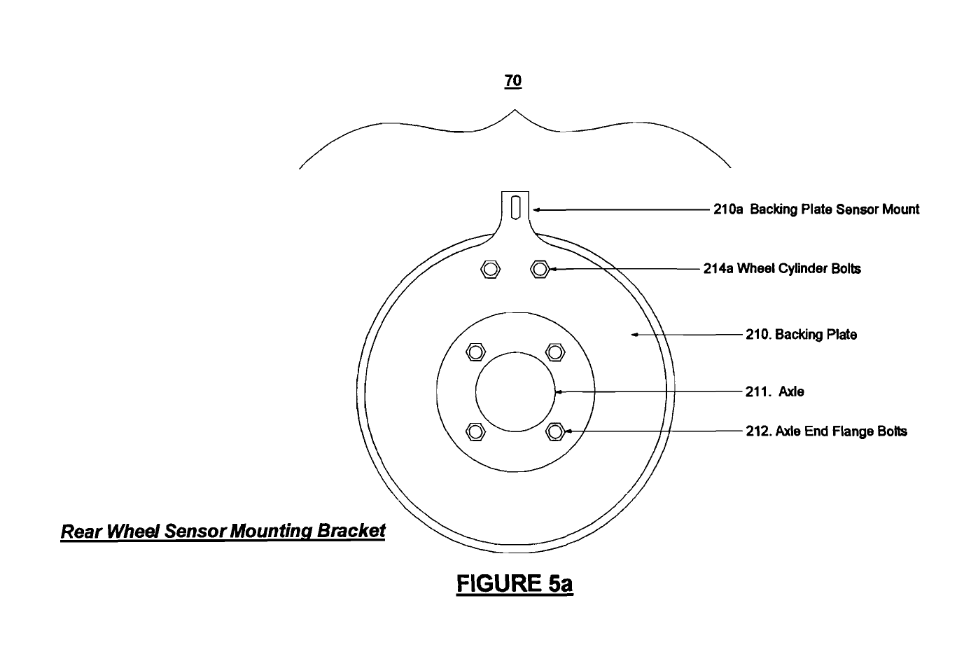

FIG. 5 is a front view of a mounting for a sensor 10 portion of a tire pressure monitoring device 100 (not shown), as installed within a rear wheel assembly 70 using placement under a plurality of wheel cylinder bolts 214, by example only, in accordance with the present invention.

FIG. 5a is a front view of a mounting for a sensor 10 portion of a tire pressure monitoring device 100 (not shown), as installed within a rear wheel assembly 70. In this assembly, the sensor mount is a continuous piece of the backing plate, herein referred to as a backing plate sensor mount 210a. The backing plate sensor mount 210a contains an elongated slot or hole so that the sensor 10 can be adjusted to match up with the pressure target module, in accordance with the present invention.

FIG. 6 is a perspective view of a tire pressure monitoring system 1000, as installed within a nose gear assembly 300 of an aerospace vehicle (not shown), such as aircraft by example only, in accordance with the present invention. The sensor 10 (not shown) is mounted to a non-revolutionary structure, such as a strut 310 and a shock strut 311 of a nose gear 321. The pressure target module 20 (not shown) is mounted to a wheel 320 of the nose gear 321. The pressure target module 20 is disposed through the wheel 320 and into the inflation media in a tire 200 using the configuration shown in FIG. 2a. Alternatively, the pressure target module 20 is disposed within the inside surface of the wheel 320 or the rear wheel spoke surface (not shown), which interfaces with the inflation media in a tire 200 using the configuration shown in FIG. 2.

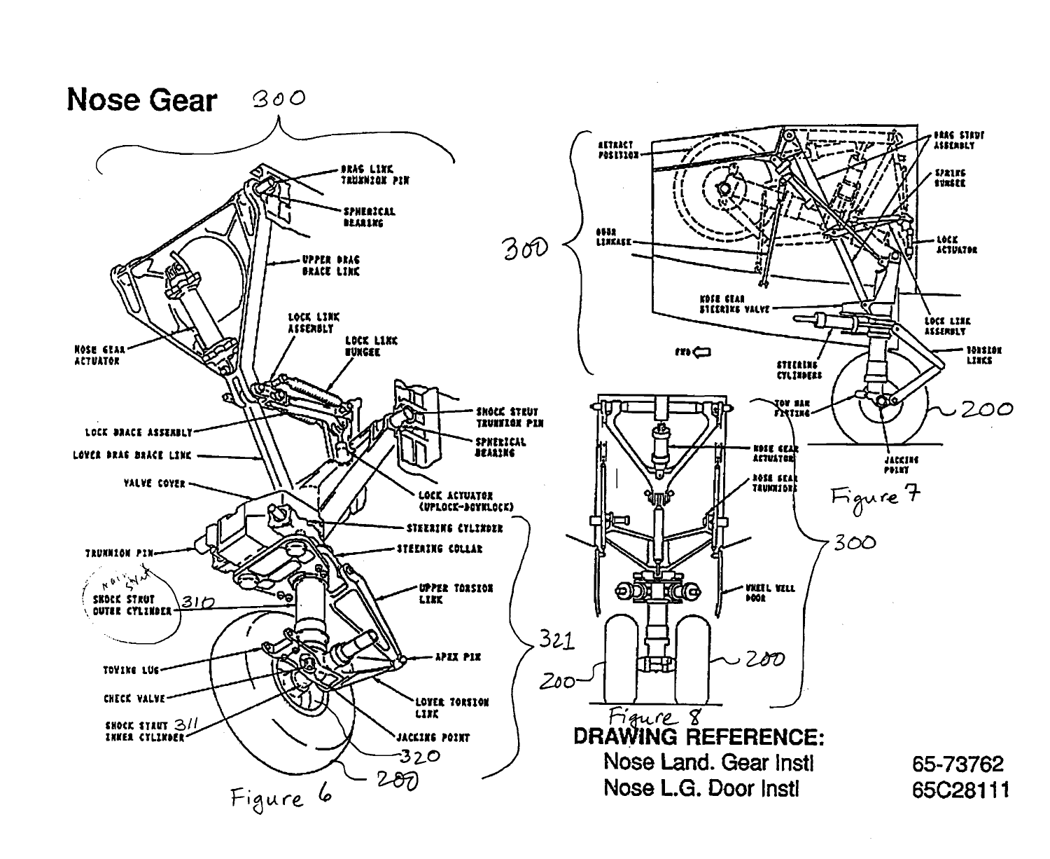

FIG. 7 is a side view of a tire pressure monitoring system 1000, as installed within a nose gear assembly 300, as shown in FIG. 6, of an aerospace vehicle (not shown), such as aircraft by example only, in accordance with the present invention.

FIG. 8 is a front view of a tire pressure monitoring system 1000 (not shown), as installed within a nose gear assembly 300, as shown in FIG. 6, of an aerospace vehicle (not shown), such as aircraft by example only, in accordance with the present invention.

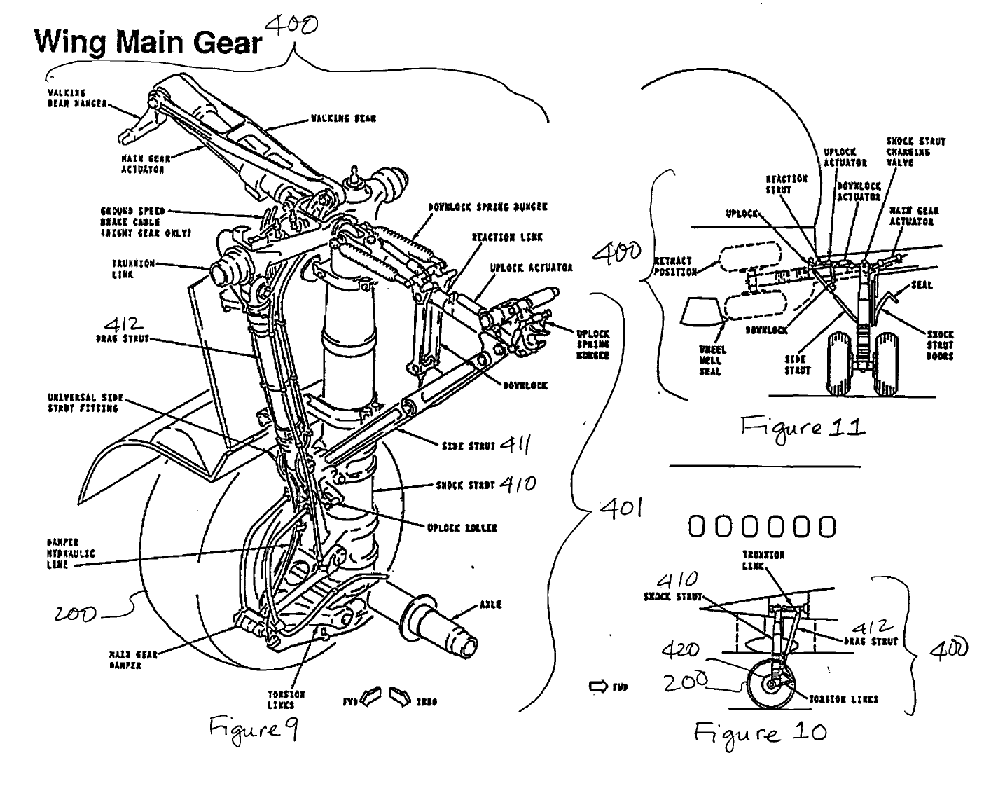

FIG. 9 is a perspective view of a tire pressure monitoring system 1000 (not shown), as installed within a wing gear assembly 400 of an aerospace vehicle (not shown), such as aircraft by example only, in accordance with the present invention. The sensor 10 (not shown) is mounted to a non-revolutionary structure, such as a strut 410 of a wing gear 401. The pressure target module 20 (not shown) is mounted to a wheel 420 of the wing gear 401. The pressure target module 20 is disposed through the wheel 420 and into the inflation media in a tire 200 using the configuration shown in FIG. 2a. Alternatively, the pressure target module 20 is disposed within the inside surface of the wheel 420 or the rear wheel spoke surface (not shown), which interfaces with the inflation media in a tire 200 using the configuration shown in FIG. 2. The aerospace vehicle landing gear comprises a component such as a nose gear 321 and a wing gear 401. The strut comprises a component such as a main strut 409 (not shown), a shock strut 410, aside strut 411, and a drag strut 412. The wheel 420 comprises a component, which interfaces with the inflation media in a tire 200 (not shown).

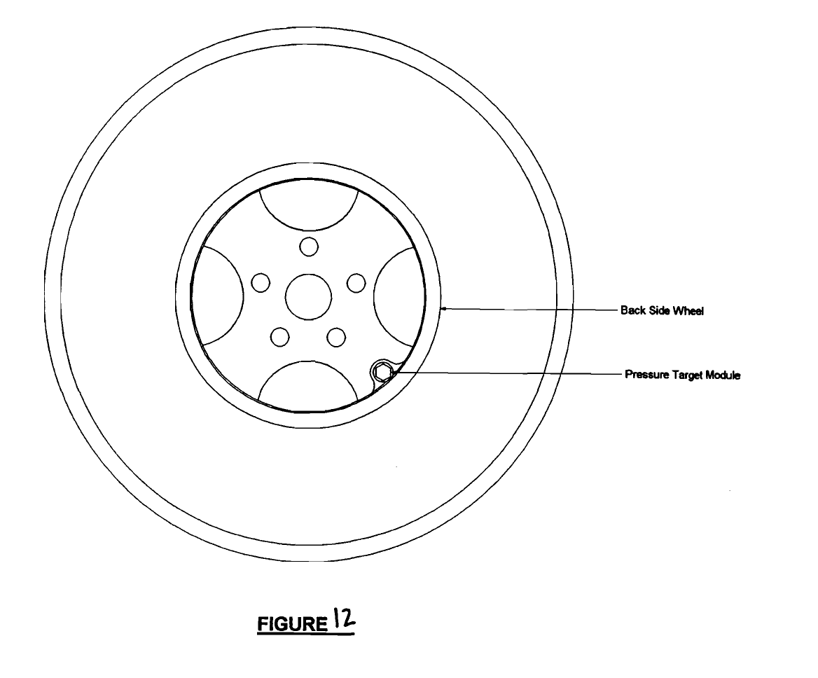

FIG. 10 is a side view of a tire pressure monitoring system 1000 (not shown), as installed within a wing gear assembly 400, as shown in FIG. 9, of an aerospace vehicle, such as aircraft by example only, in accordance with the present invention.

FIG. 11 is a front view of a tire pressure monitoring system 1000 (not shown), as installed within a wing gear assembly 400, as shown in FIG. 9, of an aerospace vehicle, such as aircraft by example only, in accordance with the present invention.

FIG. 12 is a top view of a pressure target module 20 of a tire pressure monitoring device 100 (not shown) as configured in FIG. 2, shown embedded in the inside surface of a wheel 61 or a wheel spoke surface (not shown), by example only, in accordance with the present invention.

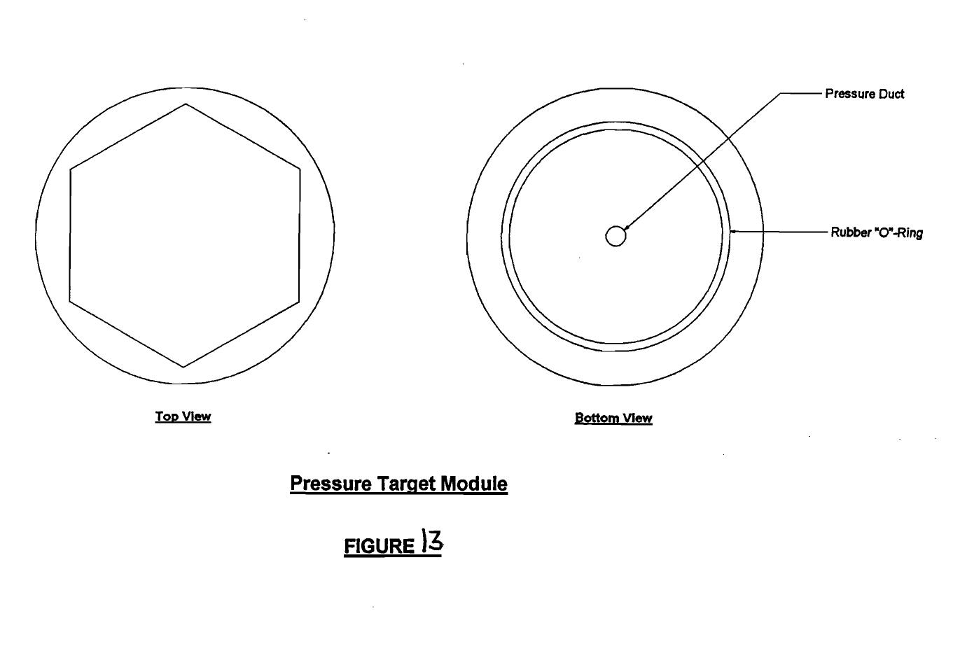

FIG. 13 is a top and bottom view of a pressure target module 20 of a tire pressure monitoring device 100 (not shown) as configured in FIG. 2, applicable for embedding within the inside surface of a wheel 61 or a wheel spoke surface (not shown), by example only, in accordance with the present invention.

The present invention method M for monitoring tire pressure of a vehicle comprises the steps of: providing a device 100 for monitoring tire pressure, the device 100 providing step comprising the steps of: providing a sensor 10 having a structure for carrying a primary current to generate a primary electromagnetic field; providing a pressure target module 20 having a structure for inducing a secondary current to generate a secondary electromagnetic field when disposed in a vicinity of the sensor 10 during a revolutionary incident; and providing a processor being in electronic communication with the sensor 10, the processor providing an alternating current to the sensor 10 of the device 100.

The method M further comprises the step of providing a light emitting diode (LED) disposed on an instrument panel (not shown) corresponding to the device 100. The device 100 providing step comprises mounting the device 100 behind a front wheel of a land vehicle. The sensor-providing step comprises mounting the sensor 10 on a non-revolutionary front structure of the land vehicle. The pressure target module 20 providing step comprises disposing the pressure target module 20 through the front wheel and into the inflation media in a tire 200 using the configuration shown in FIG. 2a or disposing the pressure target module 20 within the inside surface of the front wheel or front wheel spoke surface, which interfaces with the inflation media in a tire 200 using the configuration shown in FIG. 2. The method M further comprises the step of providing a sensor mounting bracket 11, wherein the sensor mounting bracket 11 providing step comprises fastening the sensor mounting bracket 11 to the non-revolutionary structure of the land vehicle, and wherein the sensor mounting bracket 11 providing step comprises providing the non-revolutionary structure comprising a structure such as a front steering knuckle, a front axle stub, and a front bearing housing. The method M further comprises the step of providing a sensor-mounting bracket 11 having a bore being coincident with a caliper-mounting bolt of the land vehicle. The method M further comprises the step of providing a plurality of adjustable locknuts for adjusting a position of the sensor 10. The device 100 providing step comprises mounting the device 100 behind a rear wheel of a land vehicle. The sensor 10 providing step comprises mounting the sensor 10 on a non-revolutionary rear structure of the land vehicle by a fastener such as under an axle end flange bolt and under a wheel cylinder bolt of the vehicle. The pressure target module providing step comprises disposing the pressure target module 20 through the rear wheel and into the inflation media in a tire 200 using the configuration shown in FIG. 2a or disposing the pressure target module 20 within the inside surface of the rear wheel or the rear wheel spoke surface, which interfaces with the inflation media in a tire 200 using the configuration shown in FIG. 2.

In the method M, the vehicle comprises an aerospace vehicle having landing gear, wherein the sensor 10 providing step comprises mounting the sensor 10 to a strut of the landing gear, and wherein the pressure target module-providing step comprises mounting the pressure target module 20 to a wheel of the landing gear. In the method M, the landing gear comprises a component such as a nose gear and a wing gear, wherein the strut comprises a component such as a main strut, a shock strut, a side strut, and a drag strut, and wherein the wheel comprises a wheel component, which interfaces with the inflation media in a tire 200.

Information as herein shown and described in detail is fully capable of attaining the above-described object of the invention, the presently preferred embodiment of the invention, and is, thus, representative of the subject matter, which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural and functional equivalents to the elements of the above described preferred embodiment and additional embodiments that are known to those of ordinary skill in the art are hereby expressly incorporated by reference and are intended to be encompassed by the present claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, various changes and modifications in form, material, and fabrication material detail may be made without departing from the spirit and scope of the inventions as set forth in the appended claims should be readily apparent to those of ordinary skill in the art. No claim herein is to be construed under the provisions of 35 U.S.C. §112, sixth paragraph, unless the element is expressly recited using the phrase “means for.”

### INDUSTRIAL APPLICABILITY

The present invention industrially relates to tire devices, systems, and methods. More particularly, the present invention industrially relates to tire pressure sensing devices, systems, and methods. Even more particularly, the present invention industrially relates to automotive and aerospace tire pressure monitoring devices, systems, and methods.

The claimed invention is:

1. A device for monitoring tire pressure of a vehicle, comprising:
a sensor;
a pressure target module; and
a processor in communication with the sensor.

2. A device, as recited in claim 1, wherein said pressure target module is embedded within the inside surface of a wheel.

3. A device, as recited in claim 1, wherein said pressure target module is embedded within a wheel spoke surface.

4. A device, as recited in claim 1, wherein said sensor is mounted to a sensor-mounting bracket.

5. A device, as recited in claim 4, wherein said sensor-mounting bracket is a continuous part of a shock strut.

6. A device, as recited in claim 1, wherein said sensor is mounted by way of a backing plate sensor mounting.

7. A device, as recited in claim 1, wherein said sensor has a means for carrying a primary current to generate a primary electromagnetic field; and said pressure target module has a means for inducing a secondary current to generate a secondary electromagnetic field when disposed in a vicinity of the sensor during a revolutionary incident.

8. A device, as recited in claim 1, further comprising a light emitting diode (LED) disposed on an instrument panel corresponding to said device.

9. A device, as recited in claim 1, wherein said pressure target module further comprises a housing and a pressure protector valve.

10. A device, as recited in claim 1, wherein said vehicle comprises a land vehicle or an aerospace vehicle.

11. A system for monitoring tire pressure of a vehicle, comprising:
at least one device for monitoring tire pressure, each at least one device comprising:
a sensor;
a pressure target module; and
a processor in communication with the sensor.

12. A system, as recited in claim 11, further comprising a light emitting diode (LED) disposed on an instrument panel corresponding to each at least one device.

13. A system, as recited in claim 11,
wherein the sensor is mounted on a non-revolutionary structure and
the disposition of the pressure target module is through a wheel; whereby said pressure target module interfaces with the inflation media in a tire.

14. A system, as recited in claim 11,
wherein the sensor is mounted on a non-revolutionary structure, and
the disposition of the pressure target module is embedded within a wheel spoke surface of a wheel; whereby said pressure target module interfaces with the inflation media in a tire.
